(19) United States
(12) Patent Application Publication
(10) Pub. No.: US 2007/0068291 A1
(43) Pub. Date: Mar. 29, 2007

(54) Failure-tolerant redundant actuator system

(76) Inventors: Reinhard Beatty, Blacksburg, VA (US); James A. Babinski, Saginaw, MI (US)

Correspondence Address: MORGAN & FINNEGAN, L.L.P., 3 World Financial Center, New York, NY, 10281-2101, US

(21) Appl. No.: 11/211,922

(22) Filed: Aug. 24, 2005

(51) Int. Cl. F16H 25/20

(52) U.S. Cl. 74/89.26

(57) ABSTRACT

The apparatus described provides a redundant actuator system that is tolerant of any single point failure. In the event of a single point failure in the actuator system, the other motor and corresponding ball nut can be commanded to rotate, thus providing the same function as the system had before the failure.

### FIELD OF THE INVENTION

The present invention relates generally to linear electro-mechanical actuators. More specifically, the present invention relates to providing a redundant linear electro-mechanical actuator system that is tolerant of any single point failure.

### BACKGROUND

Electro-mechanical actuators (EMA's) are devices that are responsible for moving a mechanical device, and are sometimes controlled electrically using sensors for feedback. Linear EMA's are found in a wide variety of industrial, scientific, and commercial applications, and are used where thrust, speed or position must be controlled. Example market applications of linear EMA's include general industrial, semiconductor, packaging, scientific, printing and converting, agriculture, lawn & turf, marine, patient handling, ergonomic workstations, recreational vehicles, military land and sea vehicles and aerospace.

Linear EMA's are similar in certain ways to hydraulic and pneumatic cylinders. Possessing some of the same design characteristics that made hydraulic and pneumatic cylinders popular, linear EMA's benefit from a cleaner and simpler power transmission. Linear EMA's are known to provide a simple approach to solving rigid or pivoting linear motion applications.

In general, linear EMA's are self-contained systems that convert rotary motion from a motor to linear motion. Actuators are typically operated by an electric motor. Linear motion systems driven by rotating electric motors commonly employ several rotary-to-linear conversion systems: ball screw, roller screw, lead screw, belt drive, chain drive, or rack and pinion. In screw drive systems, the motor typically rotates a ball screw, roller screw or acme screw, which translates the torque into force through a thrust tube.

Some linear EMA's use ball screws to provide smooth, accurate and efficient positioning. Such actuators contain a ball screw assembly. Typically, this ball screw assembly consists of a ball screw with a helical groove; a ball nut, also known as the outer race, with an internal groove; and one or more circuits of balls that recirculate in the grooves between the ball screw and the ball nut. This anti-friction design converts torque to thrust as either the ball screw or the ball nut turns and the other component moves in a linear direction.

Other actuators use lead screws in their operation. The lead screw typically uses a plastic or bronze solid nut that slides along the threads of the screw, much like an ordinary nut and bolt. Since there are no rolling elements between the nut and the leadscrew, lead screws typically yield only 10-60% of the motor's energy to driving the load. The remaining energy is lost to friction and dissipated as heat.

Various failure scenarios that can occur to linear EMA systems are given below.

When a linear EMA containing a ball screw is operating, the bearing balls may become fractured, trapped and/or jammed between the circuits, for example by dirt or other debris, thereby jamming the ball nut. A jammed ball nut prevents rotation of the ball nut and/or the ball screw, and therefore prevents the actuator from operating properly. In other words, if dirt or debris or a bearing ball fracture jams the recirculation of the bearing balls in the ball nut, the ball nut will become locked. A single jammed ball nut can prevent the load from moving.

In addition, when an actuator containing a ball screw assembly is operating, the ball nut may lose some or all of its bearing balls. In the event of a loss of bearing balls in the ball nut (i.e., a failed ball nut), the bearing balls are unable to serve the function of carrying the thrust load through the ball nut, and this effectively uncouples the motor from the load.

There are many other types of single point failures that can occur in linear EMA systems. Other single point failures that actuator systems may experience include for example a loss of electric function of a motor, a severed ball screw shaft, a severed mounting structure, or a failed ball spline. All of these system failures can prevent the actuator from operating properly, and therefore can prevent the load from moving.

What is needed, therefore, is an apparatus and method that provides a redundant linear EMA system that is tolerant of any single point failure which is simpler and less costly than other current arrangements.

### SUMMARY OF THE INVENTION

According to the present invention, an apparatus for a redundant actuator system that is tolerant of any single point failure is provided.

In one aspect of the invention, a method and apparatus for operating a dual redundant actuator system is provided, which is redundant in the event of a single point failure in the actuator system. One advantage of the present invention is that in the event of a single point failure in the actuator system, the other motor and corresponding ball nut is commanded to rotate, thus providing the same function as the system had before the failure.

These aspects and other objects, features, and advantages of the present invention is described in the following Detailed Description which is to be read in conjunction with the accompanying drawings.

### BRIEF DESCRIPTION OF THE DRAWINGS

FIG. 1 is a perspective view of a failure-tolerant redundant actuator of the present invention;

FIG. 2 is a top view of a failure-tolerant redundant actuator of the present invention;

FIG. 3a is a side view of a failure-tolerant redundant actuator of the present invention;

FIG. 3b is a cross-sectional view taken along axis A-A of FIG. 3a;

FIG. 3c is a cross-sectional side view taken along axis B-B of FIG. 3b; and

FIG. 3d is an exploded view of a ball nut of FIG. 3b.

### DETAILED DESCRIPTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and any additional fields in which the present invention would be of significant utility.

In critical EMA applications, certain single point failures are currently handled by creating EMA's which have dual load paths wherever a single point failure could cause the load and motor to become disconnected. For example, two parallel mounting structures are provided in place of one mounting structure, and two lead screw assemblies in place of one lead screw assembly.

Dual redundant motors are provided which are geared to the load such that the two motors share the load torque. This allows one motor to have an electrical failure and the remaining motor can take over the load and continue to operate normally. This is often referred to as a torque-summing arrangement since they are arranged to share the load.

A torque-summing arrangement of redundant motors and load paths can be made inoperative by a jam of the gearing, therefore an alternate arrangement of the gearing is provided which is referred to as a differential or speed-summing arrangement. Such an arrangement permits one motor or gear train to be jammed and permit the remaining motor to move the load at half the previous speed, hence the name “speed-summing”.

Likewise, redundant ball nuts must be arranged in a speed-summing arrangement to prevent a single jammed ball nut from rendering the actuator inoperative. One method of doing this is a linear EMA which employs a telescoping ball screw assembly. Such an assembly typically uses a speed-summing arrangement of motors and gearing to drive a ball nut. This ball nut causes a hollow ball screw to translate. This first ball screw has a second smaller ball nut mounted on the end which, in turn, drives a second smaller ball screw which is then attached to the load. In this arrangement of telescoping ball screws, a single jammed ball nut can still react torque to the other ball nut and allow no less than half the original stroke, depending on the location of the jammed ball nut.

The disadvantages of such a telescoping ball screw arrangement is that the ball screws must incorporate elaborate energy absorbing mechanical stops to accelerate the next stage when the first comes to the end of its travel. Furthermore, the hollow ball screws are difficult to machine and the entire assembly has a large number of parts which negatively affects its reliability and cost.

The present invention provides a redundant linear EMA system that is tolerant of any single point failure. Examples of various single-point failures that an actuator system may experience and that the present invention tolerates includes, but is not limited to, a jammed ball nut, a failed ball nut (i.e., a loss of bearing balls in the ball nut), a loss of electric function of a motor in the system, a severed or damaged ball screw shaft, a severed or damaged mounting structure, a failed ball spline, or a jammed gear train and/or jammed bearings.

The process of providing a failure-tolerant redundant linear EMA system as illustrated herein can be used in conjunction with, but not limited to, a lead screws and/or ball screws.

The majority of motion applications convert motor torque to linear thrust using ball screws due to their ability to convert more than 90% of the motor's torque to thrust. Ball screws provide a solution when the linear motion application requires high efficiency and low friction, high duty cycle (>50%), and/or long life and low wear. Typically the motor, for example through either a timing belt, a gear drive, or via in-line direct coupling, rotates the ball screw, which translates the torque into force by means of the screw helix angle.

In one embodiment of the present invention, the ball screw assembly contains a ball screw with a groove. The assembly also includes two rotating ball nuts each with internal grooves; and each ball nut with at least one circuit of balls that recirculate in the grooves between the ball screw and each ball nut. Each ball nut can use one or more circuits of recirculating balls which roll between the ball nut and the ball screw threads. This anti-friction design converts torque to thrust as the ball nut(s) rotate and the ball screw moves in a linear direction.

In one embodiment, the actuator includes two motor-drive assemblies, each of which includes a rotating ball nut. Each of the ball nuts are supported by bearings, and each of the ball nuts is driven by a motor. Each motor may drive its corresponding ball nut directly, or by means of gearing to increase torque. Such an actuator could be operated with both motors operating simultaneously, or could be operated with a single motor at a time. It is contemplated that both motors would operate concurrently under normal circumstances. This type of redundant motor arrangement is referred to as a speed-summing arrangement because operation of both motors simultaneously typically doubles the effective linear speed of the actuator.

Each motor-drive assembly engages with, and is joined by a single ball screw. The ball screw translates as the motor(s) rotates the ball nut(s). The ball screw shaft may or may not be hollow. A tie rod may be included inside the hollow ball screw shaft to serve the function of carrying the load in the event that the ball screw shaft is severed or damaged.

Each end portion of the ball screw has, for example, a hexagonal, polygonal, splined or some other cross-sectional shape or other non-round shape or the like, which can be guided to prevent rotation of the ball screw. Each motor-drive assembly supports a stationary anti-rotation feature, which guides the end portion of the ball screw, thus preventing rotation of the ball screw but allowing for its translation.

Each motor would have a fail-safe brake, which would prevent motor rotation when the motor was not energized. This permits the actuator to function normally in the event of loss of electric function of one of the motors, or when just single motor operation is desired. Actuators employing ball screw drive assemblies typically include a brake. One type of brake includes, but is not limited to, a spring set brake. The electrically released, spring set brake prevents backdriving when the unit is at rest, or in the case of a power failure. Backdriving is the result of the load pushing axially on the ball screw or ball nut to create rotary motion. When power is applied, the brake releases and the actuator is free to move. When power is off, springs engage the brake to hold the load in position.

In addition, each motor-drive assembly with corresponding ball nut includes provisions for mounting to stationary and/or moving structures. For example, each motor-drive assembly with corresponding ball nut may be mounted by a flange for guided loads, or mounted by trunnions or rod-end bearings for loads which require rotation. Each motor-drive assembly with corresponding ball nut may be mounted to stationary and/or moving structures using one or more mounting structures. The use of redundant mounting structures, also known as load paths, may be used so that in the event that the primary mounting structure becomes damaged or severed, a load path is maintained by the use of the secondary mounting structure. Examples of acceptable mounting structures that may be used for either the primary or secondary load path include, but is not limited to, flange mounts, trunnion mounts, rod-end bearings, clevis mounts, foot mounts, side-tapped holes, side lugs, side angle brackets, or pins.

It is contemplated that both motors would operate concurrently, however, the actuator could be operated with a single motor operating. A jammed ball nut on one channel prevents rotation of the corresponding motor and ball nut. According to one aspect of the present invention, in the event of a jammed ball nut, the actuator's control system would detect the jam of a particular ball nut by means of various sensors and would then disable the motor of the failed channel, engage its brake and continue to command motion of the remaining channel.

A jammed ball nut on a given channel could be sensed by several means, depending upon the particular control configuration. One embodiment would be to close position loops around each of the two channels such that each loop is commanded with half the total displacement desired, to be provided by a linear position feedback transducer such as a Linear Variable Differential Transformer (LVDT) or by rotary resolver feedback in combination with a home position signal within the linear stroke. Each loop accepts the actuator position feedback signal of the corresponding channel. Likewise, each channel is commanded with half the combined actuator position command. In the event of a jammed ball nut in one of the channels, the position error of that channel would increase above some allowable threshold, triggering the control to disable that channel. To compensate for the failed channel, the control would also need to set the command of the remaining channel to the actuator total command less the position of the failed channel. The symmetry of this arrangement allows it to function identically if either channel were to fail to follow the commanded position. Another example of an acceptable sensor to sense a jammed ball nut on a given channel includes, but is not limited to, electrical current sensors, torque sensors, speed sensors, force sensors, piezo-electric sensors and the like.

In such a case where a jammed ball nut prevents rotation of one of the ball nuts, the sensors would detect the failure and the actuator's control system would direct the jammed motor to be disabled and its brake engaged, thus preventing its rotation. The actuator's control system would then command the motor corresponding to the other, non-jammed ball nut to rotate, thus providing the same function as the system had before the jam. This aspect of the present invention not only permits the actuator to function normally in the event of a jammed ball nut, but also permits the actuator to function normally in the event of loss of electric function of one of the motors, or allows for just single motor operation when desired. This type of redundant motor arrangement is referred to as a speed summing arrangement because operation of both motors simultaneously typically doubles the effective linear speed of the actuator. If one channel fails, the total speed capability of the actuator is typically halved, although the actuator's load carrying capability typically remains the same.

A portion of each ball nut may include threads, for example female threads. An acceptable example of female threads included in each ball nut includes, but is not limited to, acme threads. The female threads engage with the ball thread of the ball screw to prevent loss of load in the event of total loss of bearing balls in either ball nut. The female threads do not engage the ball thread of the ball screw when the bearing balls are present in either ball nut. In the event of a loss of bearing balls in either ball nut, the female threads serve the function of carrying the thrust load through the ball nut that has lost its bearing balls. In such a case, current sensors would detect the failure by the abnormally high motor torque (proportional to current) of the failed channel and the actuator's control system would disable the motor with failed ball nut and engage its brake to prevent rotation. The control system would then command the opposite motor to carry the load.

An alternative approach to the threads is the use of a helical wire which would reside in the ball groove in a portion of the ball nut. Such a helical wire would serve the function of carrying the thrust load through the ball nut in the event it has lost all the load-carrying balls.

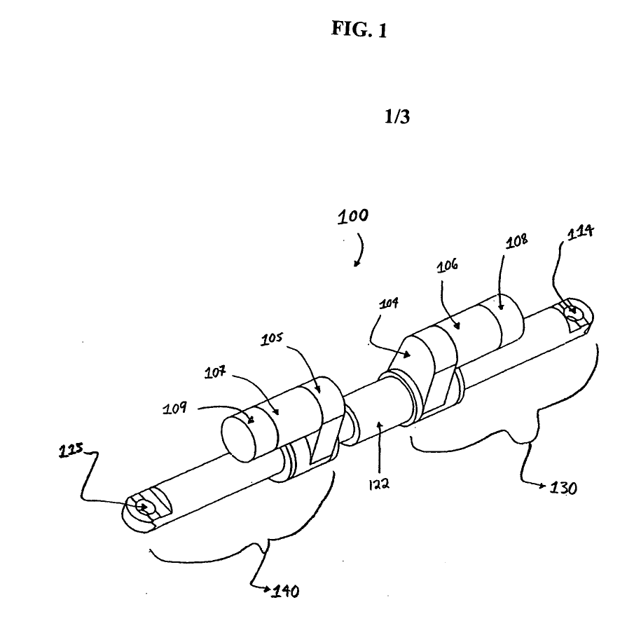

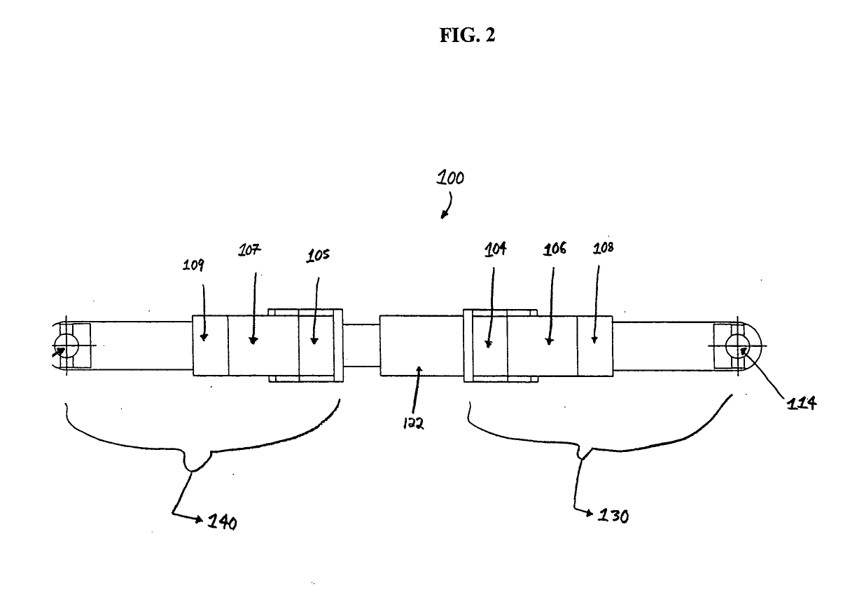

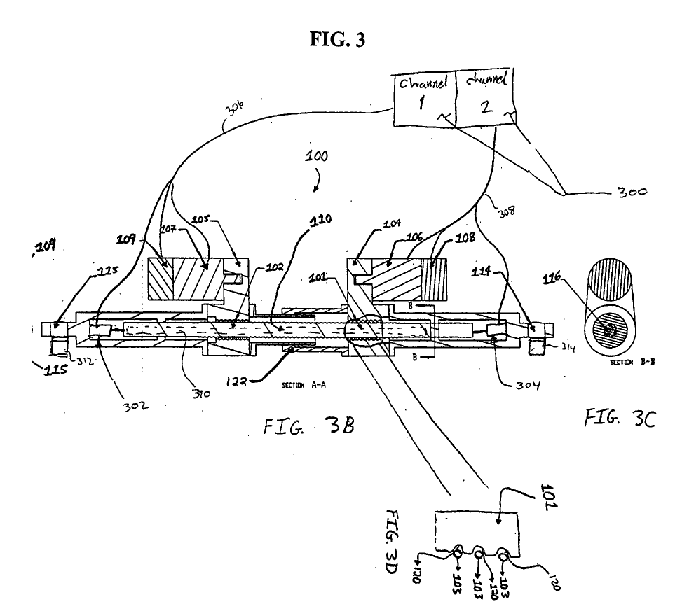

As shown in FIGS. 1-3, an apparatus for providing a failure-tolerant redundant actuator system is generally designated by the reference numeral 100 and includes a first motor-drive assembly 130 and a second motor-drive assembly 140. The failure-tolerant actuator system 100 further includes a first ball nut 101, and a second ball nut 102. As shown in FIGS. 3b and 3d, first ball nut 101 and second ball nut 102 each includes bearing balls 103. First ball nut 101 is supported by gearbox 104. Second ball nut 102 is supported by gearbox 105. First ball nut 101 is driven by first motor 106, and second ball nut 102 is driven by second motor 107. The motor mounting configurations for motors 106, 107 includes, but is not limited to, a parallel motor mounting configuration as shown in FIGS. 1-3. It is also contemplated that motors 106, 107 could be mounted in an inline motor mounting configuration. The failure-tolerant actuator system 100 also includes environmental covers 122.

First motor 106 includes first fail-safe brake 108, and second motor 107 includes second fail-safe brake 109. Fail-safe brakes 108 and 109 prevent motor rotation when motors 106 and 107 are not energized, respectively. This permits the failure-tolerant actuator system 100 to function properly in the event of a loss of electric function to either motor 106 or 107, or when just single motor operation is desired.

First motor 106 with ball nut 101, and second motor 107 with ball nut 102, engages with, and is joined by a single ball screw 110. Ball screw 110 translates as either first motor 106 rotates first ball nut 101, or second motor 107 rotates second ball nut 102, or as both motors 106, 107 rotate ball nuts 101, 102 simultaneously. The shaft of ball screw 110 may or may not be hollow. A tie rod 310 may be included, but is not so limited, inside the shaft of ball screw 110 to serve the function of carrying the load in the event that the shaft of ball screw 110 is severed or damaged.

The failure-tolerant actuator system 100 may be operated with both motors 106, 107 operating simultaneously, or could be operated with either first motor 106 or second motor 107 operating alone. This type of redundant motor arrangement is referred to as speed-summing because operation of both motors simultaneously typically doubles the effective linear speed of the actuator.

A jammed ball nut 101 or 102 would prevent rotation of the jammed ball nut 101 or 102. In the event that either ball nut 101 or 102 became jammed and/or locked, the actuator's control system or controller 300 would detect the jam of the jammed ball nut 101 or 102 by means of sensors 302, 304. The sensors may be any type of sensor as previously described. The control system may be any control system known by those in the art for the purposes described herein. The sensors 302, 304, depending on the embodiment, may be coupled to the control system by couplings 306 and 308 that are also in communication with motor 106, 107, and brakes 108, 109. The control system would then disable motor 106 or 107 of the failed channel, engage its brake 108 or 109 and continue to command motion of the remaining channel equal to the total actuator position command less the position of the failed channel. Therefore, in the event that either ball nut 101 or 102 became jammed, the other motor (either 106 or 107) corresponding to the un-jammed ball nut (either 101 or 102) would be commanded to rotate, thus providing failure-tolerant redundant actuator system 100 the same function as the system had before the jam.

Each end portion of ball screw 110 includes a hexagonal, polygonal, splined or some other cross-sectional shape or other non-round shape or the like, which can be guided to prevent rotation of ball screw 110. As shown in FIGS. 1-3, each motor-drive assembly 130 and 140 supports a stationary anti-rotation feature 116, which guides each end portion of ball screw 110, thus preventing rotation of ball screw 110 but allowing for its translation.

First motor-drive assembly 130 includes mount 114 for mounting to stationary or moving structures. Second motor-drive assembly 140 includes mount 115 for mounting to stationary or moving structures. Examples of acceptable mounts 114 and 115 include, but are not limited to, a flange mount or foot mount for guided loads, or trunnion, clevis or rod-end bearings mounts for loads which require rotation. Each motor-drive assembly 130, 140 with corresponding ball nut 101 or 102 may be mounted to stationary and/or moving structures using one or more mounting structures. The use of redundant mounts 114, 115, also known as load paths, may be used so that in the event that the primary mounting structure 114, 115 becomes damaged or severed, the load path is compensated for by the use of the secondary mounting structure 312, 314. Secondary mounts do not necessarily need to be included depending on the embodiment, but do have advantages as described herein.

As shown in FIG. 3d, a portion of each ball nut 101 and 102 includes threads 120. Acceptable examples of threads included in each ball nut includes, but is not limited to, acme threads or helical wire or the like. The threads 120 in this example are female and engage with the ball thread of ball screw 110 in the event there are no bearing balls 103 in either ball nut 101 or 102 (i.e., a failed ball nut). The female threads 120 do not engage the ball thread of ball screw 110 when the bearing balls 103 are present in either ball nut 101 or 102.

In the event of a loss of bearing balls 103 in either ball nut 101 or 102, the female threads 120 serve the function of carrying the thrust load through the ball nut 101 or 102 that has lost its bearing balls 103. In such a case, sensors would detect the failure and the actuator's control system would disable motor 106 or 107 with failed ball nut 101 or 102, and engage its brake 108 or 109 to prevent rotation. The control system 300 would then command the opposite motor 106 or 107 to carry load, thus providing failure-tolerant redundant actuator system 100 the same function as the system had before the ball nut failure.

It should be understood that the above description is only representative of illustrative examples of embodiments. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Furthermore, since numerous modifications and variations will readily occur to those skilled in the art, it is not desired that the present invention be limited to the exact construction and operation illustrated. Accordingly, all suitable modifications and equivalents that may be resorted to are intended to fall within the scope of the claims.

What is claimed is:

1. A failure-tolerant redundant actuator system, comprising:
an actuator having a ball screw with anti-rotation features;
a first motor-drive assembly having a first motor and a corresponding first rotable ball nut having bearing balls;
the first ball nut driven by the first motor and engaged with the ball screw;
a second motor-drive assembly having a second motor and a corresponding second rotable ball nut having bearing balls;
the second ball nut driven by the second motor and engaged with the ball screw; and
wherein the first and the second ball nuts have female threads to serve the function of carrying a thrust load through the first or the second ball nut that has failed.

2. The system of claim 1, further including a stationary anti-rotation feature of each motor-drive assembly to guide each anti-rotation feature of the ball screw, for preventing rotation of the ball screw but allowing for the ball screw to translate.

3. The system of claim 1, wherein each anti-rotation feature of the ball screw has a polygonal, splined or other non-round shape.

4. The system of claim 1, further including a control system and sensors.

5. The system of claim 4, wherein the sensors are electrical current sensors.

6. The system of claim 1, wherein the ball screw translates with respect to the first motor as the first motor rotates the first ball nut.

7. The system of claim 1, wherein the ball screw translates with respect to the second motor as the second motor rotates the second ball nut.

8. The system of claim 1, wherein the ball screw translates with respect to the first motor as the first motor rotates the first ball nut, and wherein the ball screw translates with respect to the second motor as the second motor rotates the second ball nut.

9. The system of claim 1, wherein each motor further includes a brake for preventing rotation of the failed motor-drive assembly to allow the opposite motor-drive assembly to carry the load.

10. The system of claim 1, wherein the female threads of the first and the second ball nuts are acme threads or a helical wire.

11. The system of claim 1, wherein the female threads or helical wire of the first ball nut engage with the ball thread of the ball screw when the bearing balls are not present in the first ball nut for carrying the thrust load through the first ball nut, and wherein the female threads or helical wire of the first ball nut do not engage with the ball thread of the ball screw when the bearing balls are present in the first ball nut.

12. The system of claim 1, wherein the female threads or helical wire of the second ball nut engage with the ball thread of the ball screw when the bearing balls are not present in the second ball nut for carrying the thrust load through the second ball nut, and wherein the female threads or helical wire of the second ball nut do not engage with the ball thread of the ball screw when the bearing balls are present in the second ball nut.

13. The system of claim 1, further including a primary mounting structure in communication with at least one motor-drive assembly.

14. The system of claim 1, wherein the actuator is operated with both the first motor and the second motor operating simultaneously.

15. The system of claim 1, wherein the actuator is operated with the first motor operating alone.

16. The system of claim 1, wherein the actuator is operated with the second motor operating alone.

17. The system of claim 1, wherein the first motor further includes at least one mounting load path and the second motor further includes at least one mounting load path.

18. The system of claim 1, wherein the first ball nut is driven by a first motor having gearing to increase torque and the second ball nut is driven by a second motor having gearing to increase torque.

19. The system of claim 1, wherein the ball screw shaft further defines a hollow space and the hollow ball screw shaft further includes a tie rod disposed inside the hollow ball screw shaft to serve the function of carrying the load in the event that the ball screw shaft is severed or damaged.

20. A failure-tolerant redundant actuator system, comprising:
an actuator having a rotary to linear conversion system with anti-rotation features;
a first motor-drive assembly having a first motor and a corresponding first rotable nut having bearing balls;
the first nut driven by the first motor and engaged with the rotary to linear conversion system;
a second motor-drive assembly having a second motor and a corresponding second rotable nut having bearing balls;
the second nut driven by the second motor and engaged with the rotary to linear conversion system; and
wherein the first and the second nuts have threads to serve the function of carrying a thrust load through the first or the second nut that has failed.

21. The system of claim 20, wherein the rotary to linear conversion system is a lead screw and the first and second nuts are lead nuts.

22. A failure-tolerant redundant actuator system, comprising:
an actuator having a rotary to linear conversion system with anti-rotation features;
a first motor-drive assembly having a first motor and a corresponding first rotable nut having bearing balls;
the first nut driven by the first motor and engaged with the rotary to linear conversion system;
a second motor-drive assembly having a second motor and a corresponding second rotable nut having bearing balls;
the second nut driven by the second motor and engaged with the rotary to linear conversion system;
a primary mounting structure and a secondary mounting structure in communication with each motor-drive assembly in the event that the primary mounting structure becomes damaged or severed, a load path is maintained by the use of the secondary mounting structure; and
wherein the first and the second nuts have threads to serve the function of carrying a thrust load through the first or the second nut that has failed.
